(19) United States
(12) Patent Application Publication
(10) Pub. No.: US 2007/0039292 A1
(43) Pub. Date: Feb. 22, 2007

(54) Cyclone dust collecting apparatus for vacuum cleaner

(75) Inventors: Jang-keun Oh, Gwangju-city (KR); Hak-bong Lee, Jeollanam-do (KR)

Correspondence Address: Paul D. Greeley;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/349,780

(22) Filed: Feb. 8, 2006

(30) Foreign Application Priority Data
Aug. 22, 2005 (KR) 10-2005-0076931

(51) Int. Cl. B01D 50/00

(52) U.S. Cl. 55/337

(57) ABSTRACT

The present invention is a cyclone dust collecting apparatus for a vacuum cleaner in which an air-whirling space and a contaminant collecting space are separated from each other. The cyclone dust collecting apparatus for the vacuum cleaner according to the present invention comprises a cyclone body connected to an extension tube; an inner cover provided at a lower side of the cyclone body, the inner cover having a hollow conical shape with an opened upper and lower ends; a grill unit through which the air is discharged, the grill unit being provided at a lower end of an air discharge tube of the cyclone body in the inner cover; and a contaminant receptacle for receiving a contaminant fallen from the inner cover, the contaminant receptacle being provided at a lower side of the inner cover.

### CROSS-REFERENCE TO RELATED APPLICATIONS

This application claims benefit under 35 U.S.C. § 119(a) of Korean Patent Application No. 2005-76931, filed Aug. 22, 2005, the entire contents of which are incorporated herein by reference.

### BACKGROUND OF THE INVENTION

1. Field of the invention

The present invention relates to a vacuum cleaner. More particularly, the present invention relates to a cyclone dust collecting apparatus for a vacuum cleaner.

2. Description of the Related Art

The vacuum cleaner is an apparatus for sucking air, dust and contaminant using a suction force generated by a motor. Accordingly, the vacuum cleaner is provided with a dust collecting apparatus for separating dust or dirt and the like (hereinafter, referred to as “contaminant”) from the sucked air and collecting them. To this end, the various types of dust collecting apparatuses have been used in the vacuum cleaner. In recent, a cyclone dust collecting apparatus has been widely used.

FIG. 1 illustrates one example of a cyclone dust collecting apparatus for a vacuum cleaner according to a conventional art.

Referring to FIG. 1, a cyclone dust collecting apparatus 1 for a vacuum cleaner comprises a cyclone body 3 and a contaminant receptacle 7.

The cyclone body 3 is provided between a first extension tube 8 and a second extension tube 9 connecting a brush (not shown) and a main body (not shown) of the vacuum cleaner. The cyclone body 3 is used for forming a whirling helical vortex current of the sucked air and includes a suction port 4 coupled with the first extension tube 8 at the brush side and an air discharge tube 6 connected to the second extension tube 9 at the main body side to discharge the air removed of the contaminant to the main body. A grill member 5 is provided at a lower side of the cyclone body 3, this grill member is communicated with the air discharge tube 6.

The contaminant receptacle 7 is provided at a lower side of the cyclone body 3 and collects the contaminant after separation from the air being whirled.

Accordingly, the contaminant-laden air sucked from the brush is sucked into the cyclone body 3 through the first extension tube 8 and the suction port 4. The contaminant-laden air sucked in the cyclone body 3 forms the whirling helical vortex current in the contaminant receptacle 7. Then, the contaminant is separated from the contaminant-laden air by a centrifugal force generated by the whirling helical vortex current, and so the contaminant falls and accumulates in the contaminant receptacle 7.

The air removed of the contaminant is discharged to the air discharge tube 6 of the cyclone body 3 through the grill member 5. The air discharged to the air discharge tube 6 is discharged to an outside of the main body of the vacuum cleaner through the second extension tube 9.

However, since the contaminant receptacle 7 functions as both roles for separating and collecting the contaminant, such conventional cyclone dust collecting apparatus 1 for the vacuum cleaner has the problems that the dust collection efficiency decreases and the collected contaminant is re-scattered.

Also, in the cyclone dust collecting apparatus 1 for the vacuum cleaner as described above, a turbulent flow is formed by an inertial force of a whirling flow of the purified air and purified air is entered to an inside of the air discharge tube 6 through the grill member 5. Due to the turbulent flow of air discharged through the air discharge tube 6, a pressure loss may be caused. Therefore, the above cyclone dust collecting apparatus has the problem that, if the pressure loss is generated in the air discharge tube 6, a load applied to a vacuum generation source (not shown) is increased, and so the power consumption becomes large.

In addition, since, compared with the cyclone body 3, the air discharge tube 6 has a relatively small surface area, a flow rate of the purified air entering the air discharge tube 6 is rapidly increased. Accordingly, the above cyclone dust collecting apparatus has the problem that, once the flow rate of air is rapidly increased as described, the noise becomes large.

### SUMMARY OF THE INVENTION

An aspect of the present invention is to solve at least the above problems and/or disadvantages and to provide at least the advantages described below. Accordingly, an aspect of the present invention is to provide a cyclone dust collecting apparatus for a vacuum cleaner whose dust collection efficiency is high and which prevents the collected contaminant from being re-scattered.

Another object of the present invention is to provide a cyclone dust collecting apparatus for a vacuum cleaner that stabilizes a flow of air discharged to an air discharge tube to enable reduced noise and power consumption.

According to one embodiment proposed to achieve the above-described aspect, there is provided the cyclone dust collecting apparatus for a vacuum cleaner comprising: a cyclone body connected to an extension tube; an inner cover provided at a lower side of the cyclone body, the inner cover has a hollow conical shape with an opened upper and lower ends; a grill unit through which the air is discharged, the grill unit is provided at a lower end of an air discharge tube of the cyclone body in the inner cover; and a contaminant receptacle for receiving a contaminant fallen from the inner cover, the contaminant receptacle is provided at a lower side of the inner cover.

It is preferable that the grill unit has a backflow preventing member extending from a lower end of the grill unit to an outside of a lower end of the inner cover.

The back flow preventing member comprises a skirt spaced apart from an opened lower end of the inner cover and having a diameter that is the same as or larger than that of the opened lower end of the inner cover; and an extension column connecting the skirt and a lower end of the grill unit.

It is preferable that the grill unit is attachably/detachably coupled with at a lower end of the air discharge tube. Also, it is preferable that the grill unit is sized such that the grill unit can be passed through the opened lower end of the inner cover.

Further, it is preferable that the grill unit has a truncated cone shape that is similar to a shape of the inner cover.

According to another embodiment proposed to achieve the above-described aspect, there is provided the cyclone dust collecting apparatus for a vacuum cleaner comprising: a cyclone body connected to an extension tube; a grill unit being provided at a lower end of an air discharge tube of the cyclone body for filtering contaminant contained in the air which is discharging, the grill unit including a plurality of air-guiding members for stabilizing the air discharged to the air discharge tube; and a contaminant receptacle for receiving the contaminant fallen from the air which is sucked from the cyclone body and is whirling, the contaminant receptacle being provided at a lower side of the cyclone body.

In the cyclone dust collecting apparatus, the grill unit further comprises a lattice member for filtering contaminant contained in the air which is discharging to the air discharge tube, the plurality of the air-guiding members are provided at an inside of the lattice member to stabilize the air which is discharging through the lattice member.

Further, the grill member may comprise a hollow cylindrical shaped grill member in fluid communication with the air discharge tube; a plurality of air-guiding member protruding on an inside surface of the grill member in the shape of a plate and having a curved section and a linear section; and a lattice member provided at a lower side of the grill member and having an approximately truncated cone shape.

Here, it is preferable that each of the plurality of air-guiding members has a lower end extended to an inside of the lattice member.

Further, the grill unit may comprise four air-guiding members formed inside of the grill body at angular intervals of 90°. Also, it is preferable that the grill unit has an air-direct passage formed at a central portion thereof, the air entering the air discharge tube is directly discharged through the air-direct passage so that the air is not guided by four air-guiding members.

According to the cyclone dust collecting apparatus for the vacuum cleaner of the present invention as described above, a space in which sucked contaminant-laden air is whirled is separated from a space in which contaminant is accumulated by an inner cover. Thus, a dust collection efficiency is enhanced and it is possible to prevent the contaminant collected in a contaminant receptacle from being re-scattered.

Further, according the present invention, since a skirt prevents the contaminant collected in the contaminant receptacle from backflowing to a grill unit, the dust collection efficiency is enhanced and it is possible to provide the cyclone dust collecting apparatus for the vacuum cleaner that can prevent the contaminant collected in the contaminant receptacle from backflowing.

Also, in a case that there is need to clean the grill unit, the grill unit can be separated through an opened lower end of an inner cover without separating the inner cover.

In addition, according to the cyclone dust collecting apparatus for the vacuum cleaner of the present invention, the purified air from which the contaminant is separated by a centrifugal force generated by the whirling helical vortex current is passed through the grill unit. In this manner, the contaminant remaining in the purified air is removed by the lattice member and the flow of the purified air is stabilized by the plurality of air-guiding members so that the pressure loss and noise caused by a turbulent flow generated in the grill unit is reduced. According to the present invention, accordingly, since the pressure loss caused by the turbulent flow is reduced, a load applied to a vacuum generating source is reduced, and so the electrical power required for driving the dust collecting apparatus for the vacuum cleaner can be saved.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a view of a prior art cyclone dust collecting apparatus for a vacuum cleaner;

FIG. 2 is a view of a cyclone dust collecting apparatus for a vacuum cleaner according to a first embodiment of the present invention;

FIG. 3 is a sectional perspective view of the cyclone dust collecting apparatus of FIG. 2;

FIG. 4 is a view of a cyclone dust collecting apparatus for a vacuum cleaner according to a second embodiment of the present invention;

FIG. 5 is a partially exploded rear cross-sectional view of the cyclone dust collecting apparatus of FIG. 4;

FIG. 6 is a perspective view of a cyclone dust collecting apparatus for a vacuum cleaner according to a third embodiment of the present invention;

FIG. 7 is a perspective view of a grill unit of the cyclone dust collecting apparatus of FIG. 6;

FIG. 8 is a perspective view of the grill unit of FIG. 7 seen from an upper side;

FIG. 9 is a sectional perspective view of the grill unit of FIG. 8 taken along line I-I in FIG. 8; and

FIG. 10 is a perspective view of a cyclone dust collecting apparatus for the vacuum cleaner according to a fourth embodiment of the present invention.

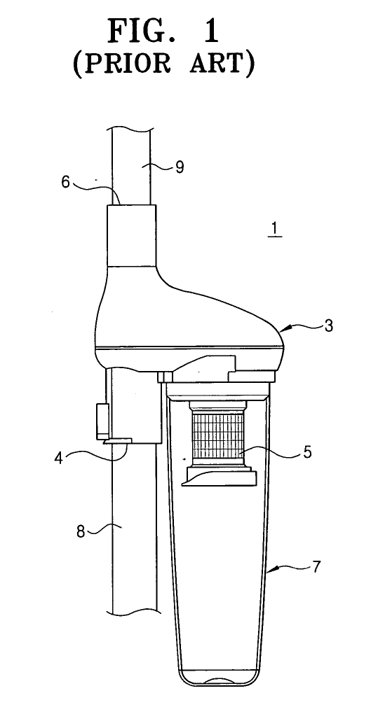

### DETAILED DESCRIPTION OF THE EXEMPLARY EMBODIMENTS

Hereinafter, an embodiment of the present invention will be described in detail with reference to the accompanying drawing figures.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

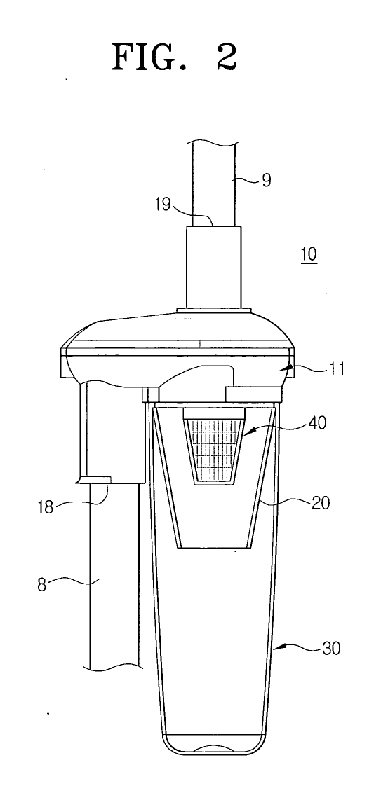

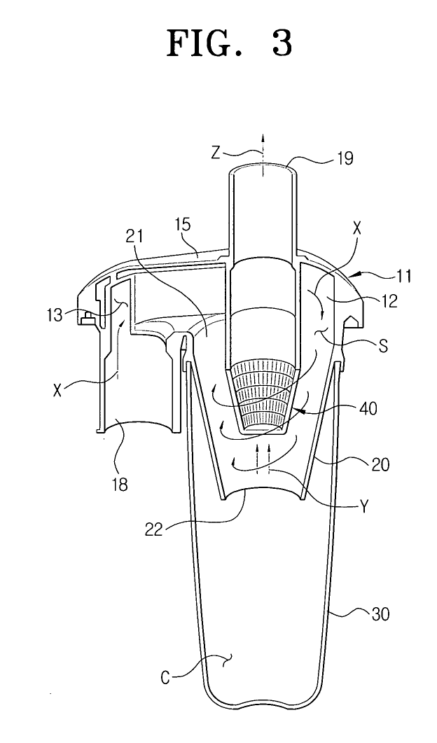

Referring to FIG. 2 and FIG. 3, a cyclone dust collecting apparatus 10 for a vacuum cleaner according to a first embodiment of the present invention is provided. Cyclone dust collecting apparatus 10 comprises a cyclone body 11, a grill unit 40, an inner cover 20, and a contaminant receptacle 30.

The cyclone body 11 is provided between a first extension tube 8 and a second extension tube 9 and comprises a side wall 12, an air suction passage 13, an air discharge tube 19, and an upper cover 15.

The side wall 12 forms a main frame of the cyclone body 11 and has a hollow cylindrical shape. In cooperation with the upper cover 15 and the inner cover 20, the side wall forms a portion of a whirling space S (see FIG. 3) in which contaminant-laden air X sucked in the cyclone body 11 and containing contaminants is rotated.

An air suction tube 18 is formed at a side of the side wall 12 and is parallel with the side wall 12. The air suction tube 18 functions as an inlet through which the contaminant-laden air X that is passed through the first extension tube 8 enters the cyclone dust collecting apparatus 11. Accordingly, the air suction tube 18 is coupled with the first extension tube 8, which is in fluid communication with a brush (not shown). Also, it is preferable that the air suction tube 18 has a hollow cylindrical shape.

The air suction passage 13 is formed at an inside of the side wall 12 so as to connect the air suction tube 18 and the whirling space S and guides the contaminant-laden air X sucked in the air suction tube 18 to form a whirling helical vortex current in the whirling space S.

The air discharge tube 19 is provided at a center of the whirling space S surrounded by the side wall 12 and has a hollow cylindrical shape. The air discharge tube 19 functions as a passage through which the purified air Y purified by centrifugal-separating the contaminants in the whirling space S is discharged. An upper end of the air discharge tube 19 is connected to the second extension tube 9, which is in communication with a main body of the vacuum cleaner (not shown).

The upper cover 15 is formed such that upper sides of the side wall 12 and the air suction tube 18 are covered with the upper cover 15. Accordingly, the upper cover 15 forms an upper side of the air suction passage 13 and an upper side of the whirling space S.

The inner cover 20 is provided at a lower side of the cyclone body 11, the inner cover 20 and the side wall 12 form the whirling space S. The inner cover 20 has an approximately hollow truncated cone shape with opened upper and lower ends. An opened upper end 21 has a diameter corresponding to that of the side wall 12 and an opened lower end 22 has a diameter which is smaller than that of the opened upper end 21. In some embodiments, the inner cover 21 can be made from transparent acrylic material.

The grill unit 40 is installed at a lower end of the air discharge tube 19 and has an approximately hollow truncated cone, which is smaller than the inner cover 20 in size. Accordingly, the grill unit 40 is located at a center of the whirling space S. A plurality of grill holes 41 is formed on the grill unit 40. The grill holes 41 separate fine dust contained in the purified air Y.

The contaminant receptacle 30 defines a space C for collecting the contaminant separated in the whirling space S in the inner cover 20 by a centrifugal force and for collecting the fine dust separated by the grill unit 40. The contaminant receptacle 30 has an approximately hollow cylindrical shape and is provided in the cyclone body 11 so that it is placed at a lower side of the inner cover 20. To this end, an upper end of the contaminant receptacle 30 is opened such that the contaminant receptacle 30 is coupled with the cyclone body 11, a lower end thereof is closed such that the contaminant receptacle 30 can receive the contaminant fallen from the inner cover 20 in space C. In addition, the contaminant receptacle 30 is installed attachably/detachably at a lower side of the cyclone body 11. Since the contaminant receptacle 30 is installed attachably/detachably at the cyclone body 11, when a certain amount of the contaminant is accumulated in the contaminant receptacle 30, the user separates only the contaminant receptacle 30 from the cyclone body 11 and can dump the contaminant collected in the contaminant receptacle 30. And, in order to easily verify the amount of contaminant collected in the contaminant receptacle 30, it is preferable to make the contaminant receptacle 30 from transparent acrylic material.

Below, an operation of the cyclone dust collecting apparatus 10 according to the first embodiment of the present invention is described with reference to accompanied FIG. 2 and FIG. 3.

When a vacuum generating source (not shown) is turned on, the contaminant-laden air X sucked from the brush (not shown) enters the air suction tube 18 through the first extension tube 8. The contaminant-laden air X is passed through the air suction passage 13 to form a whirling helical vortex current and then enters the whirling space S formed by the side wall 12 and the inner cover 20. While the contaminant-laden air X is whirled in the inner cover 20, the contaminant contained in the contaminant-laden air X is separated by a centrifugal force. The separated contaminant falls in the contaminant receptacle 30 through the opened lower end 22 of the inner cover 20 and accumulates in the contaminant receptacle 30. The purified air Y from which the contaminant is separated enters the air discharge tube 19 through the grill unit 40. When the purified air Y passes through the grill unit 40, fine dusts and the like which was not separated from the air and remains in the purified air is filtered-by the plurality of grill holes 41 to form cleaned air Z. The purified air Y passes through the grill unit 40 and the cleaned air Z enters the air discharge tube 19, passes through the second extension tube 9 to the main body of the vacuum cleaner (not shown), and then is discharged to an exterior.

In the cyclone dust collecting apparatus 10 according to the first embodiment of the present invention as described above, since the space S in which the sucked contaminant-laden air X is whirled is separated from the space C in which the contaminant is accumulated by the inner cover 20, the dirt is prevented from re-entering purified air Y from the space C so that the dust collection efficiency is enhanced, and it is possible to prevent the contaminant collected in the contaminant receptacle 30 from be re-scattering.

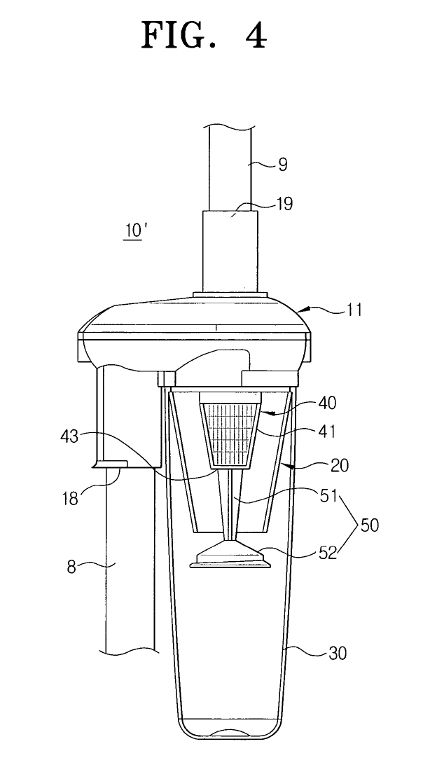

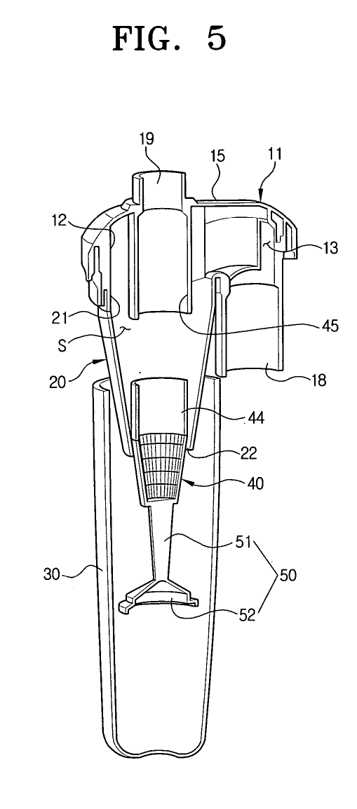

Below, according to another aspect of the present invention, the cyclone dust collecting apparatus according to the second embodiment of the present invention is described with reference to FIG. 4 and FIG. 5.

Referring to FIG. 4 and FIG. 5, a cyclone dust collecting apparatus 10′ according to the second embodiment of the present invention comprises the cyclone body 11, the grill unit 40, a backflow preventing member 50, the inner cover 20, and the contaminant receptacle 30.

The grill unit 40 is installed at a lower end of the air discharge tube 19 and has an approximately hollow truncated cone that is smaller than the inner cover 20 in size. A plurality of grill holes 41 is formed on the grill unit 40. These grill holes 41 separate the contaminant contained in the purified air Y to be discharged.

The backflow preventing member 50 is provided to prevent the contaminant collected in the contaminant receptacle 30 from backflowing through the opened lower end 22 of the inner cover 20. The backflow preventing member 50 extends from a lower end 43 of the grill unit 40 to an outside of the opened lower end 22 of the inner cover 20. This backflow preventing member 50 includes a skirt 52 and an extension column 51. The skirt 52 corresponds in size to the opened lower end 22 of the inner cover 20 and is spaced apart from the opened lower end 22 of the inner cover 20 by extension column 51 so that the contaminant can fall through the opened lower end 22 of the inner cover 20. It is desirable that a diameter of the skirt 52 is the same as or larger than that of the opened lower end 22 of the inner cover 20. The extension column 51 connects the skirt 52 and the lower end 43 of the grill unit 40 and functions as a role for fixing the skirt 52 to the grill unit 40. It is preferable that the extension column 51 is fixed to the lower end 43 of the grill unit 40 for preventing it from separating from the grill unit 40.

On the other hand, the grill unit 40 can be attachably/detachably coupled with a lower end 45 of the air discharge tube 19. That is, the grill unit 40 is installed such that an upper end 44 of the grill unit 40 can be separated from and coupled with the lower end 45 of the air discharge tube 19. At this time, any known one touch connection method can be applicable to the methods for separating/coupling the grill unit 40 from/with the air discharge tube 19, and so a detailed description thereon is omitted. An example of one touch connection method is a screw connection method in which the upper end of the grill unit 40 is formed as a male screw and the lower end 45 of the air discharge tube 19 is formed as a female screw. Also, the grill unit 40 is sized such that the grill unit 40 can be passed through the opened lower end 22 of the inner cover 20, and so there is no need to separate the inner cover 20 when the grill unit 40 is separated from the air discharge tube 19. That is, a maximum diameter of the grill unit 40 should be smaller than a diameter of the opened lower end 22 of the inner cover 20.

Since the structures and functions of the cyclone body 11, the inner cover 20 and the contaminant receptacle 30 of the cyclone dust collecting apparatus 10′ according to this embodiment are the same as those of the members of the cyclone dust collecting apparatus 10 according to the first embodiment, a detailed description thereon is omitted.

Below, an operation of the cyclone dust collecting apparatus 10′ according to the second embodiment of the present invention is described with reference to accompanied FIG. 4 and FIG. 5.

When a vacuum generating source (not shown) is turned on, the contaminant-laden air sucked from the brush (not shown) enters the air suction tube 18 through the first extension tube 8. The contaminant-laden air passes through the air suction passage 13 to form a whirling helical vortex current and then enters the whirling space S formed by the side wall 12 and the inner cover 20. While the contaminant-laden air is whirled in the inner cover 20, the contaminant contained in the contaminant-laden air is separated by a centrifugal force. The separated contaminant falls in the contaminant receptacle 30 through the opened lower end 22 of the inner cover 20 and accumulates in the contaminant receptacle 30. At this time, since a space is formed between the opened lower end 22 of the inner cover 20 and the skirt 52, the contaminant falling from the inner cover 20 is not blocked by the skirt 52 and received in the contaminant receptacle 30. Also, in case the contaminant collected in the contaminant receptacle 30 is whirled by the whirling helical vortex current and backflows toward the opened lower end 22 of the inner cover 20, a flow of the contaminant is blocked by the skirt 52, and so it is possible to prevent the contaminant from backflowing to the grill unit 40.

The purified air from which the contaminant is separated enters the air discharge tube 19 through the grill holes 41 of the grill unit 40. When the purified air passes through the grill unit 40, fine dusts and the like which was not separated from the air and is remained in the purified air is filtrated by the plurality of grill holes 41 to form cleaned air Z. The cleaned air Z enters the air discharge tube 19, is passed through the second extension tube 9 and the main body of the vacuum cleaner (not shown), and is then discharged to an exterior.

Also, in a case that there is need to clean the grill unit 40, if the user manipulates the grill unit 40 using the skirt 52 as a knob, the upper end 44 of the grill unit 40 can be separated from the lower end 45 of the air discharge tube 19. At this time, since the maximum diameter of the grill unit 40 is smaller than a diameter of the opened lower end 22 of the inner cover 20, the grill unit 40 can be separated from the cyclone body 11 and the inner cover 20 without separating the inner cover 20.

In the cyclone dust collecting apparatus 10′ according to the second embodiment of the present invention as described above, since the space S in which the sucked contaminant-laden air is whirled is separated from the space C by the inner cover 20 and the skirt 52, the contaminant collected in the contaminant receptacle 30 is prevented from backflowing toward the grill unit 40. In this manner, the dust collection efficiency is enhanced and it is possible to prevent the contaminant collected in the contaminant receptacle 30 from backflowing. Also, in a case that there is need to clean the grill unit 40, only the grill unit 40 can be drawn out through the opened lower end 22 of the inner cover 20 without separating the inner cover 20, and so the cyclone dust collecting apparatus 10′ according to the second embodiment of the present invention can be conveniently cleaned.

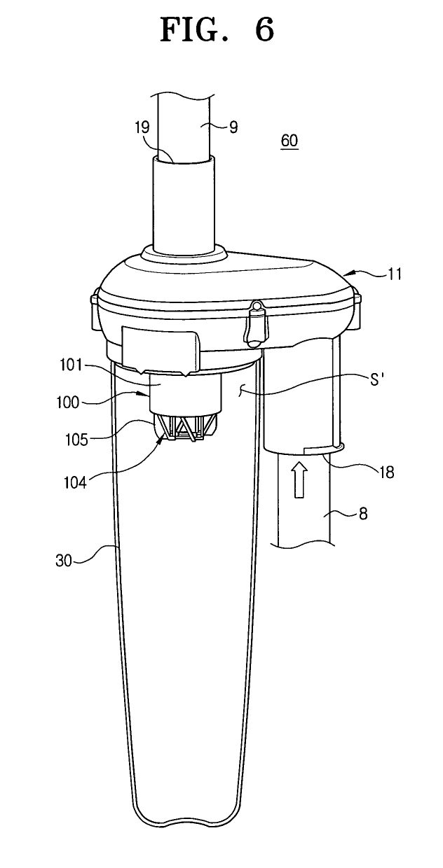

Below, according to another aspect of the present invention, the cyclone dust collecting apparatus according to the third embodiment of the present invention is described with reference to accompanied FIG. 6 to FIG. 9.

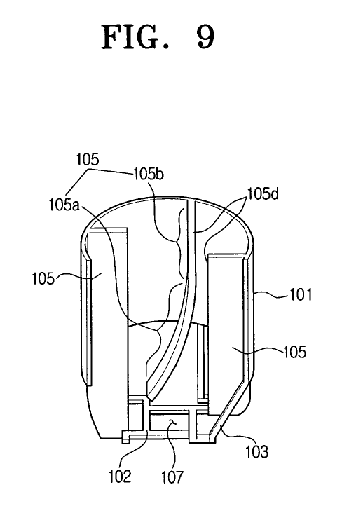

Referring to FIG. 6 to and FIG. 9, a cyclone dust collecting apparatus 60 according to the third embodiment of the present invention comprises the cyclone body 11, a grill unit 100 and the contaminant receptacle 30.

The cyclone dust collecting apparatus 60 according to this embodiment of the present invention is characterized in that the grill unit 100 installed at a lower end of the air discharge tube 19 of the cyclone body 11 and having a function for filtering the contaminant contained in the purified air being discharging and a function for stabilizing the air discharged to the air discharge tube 19.

The grill unit 100 as described above includes a grill body 101, a lattice member 104, and a plurality of air-guiding members 105.

The grill body 101 is communicated with a lower end of the air discharge tube 19 and has an approximately hollow cylindrical shape.

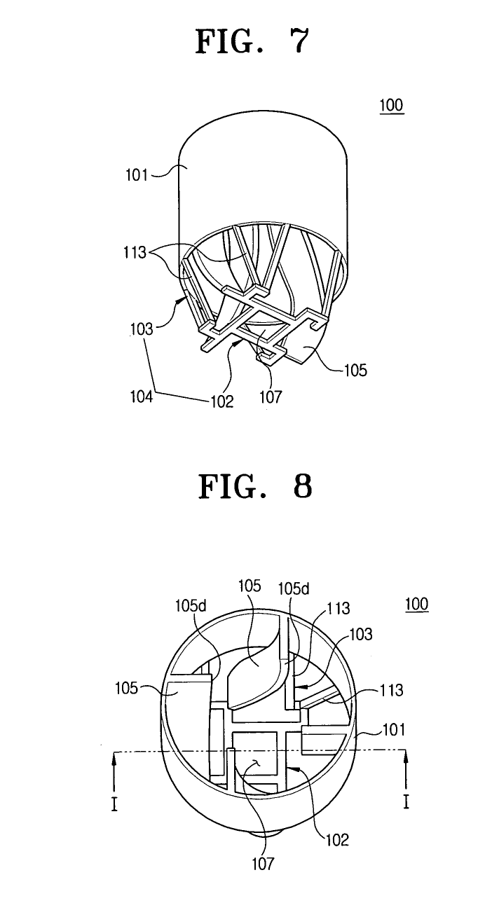

The lattice member 104 is provided for filtrating fine dust and the like remaining in the purified air that is centrifugally separated and discharged to the air discharge tube 19. The lattice member 104 is installed at a lower side of the grill body 101 and formed with a plurality of bars 113 to have an approximately truncated cone shape. Referring to FIG. 7 and FIG. 8, the lattice member 104 is formed from a lower lattice 102 and a side lattice 103. The lower lattice 102 has an approximately rectangular shape and a size that is smaller than a diameter of the grill member 101. The side lattice 103 connects the lower lattice 102 and the grill body 101 and functions as a role for filtering the air sucked to a space between the lower lattice 102 and the grill body 101. That is, the side lattice 103 includes a plurality of bars 113 connected to a lower end the grill body 101 at each vertex of the rectangular shaped lower lattice 102. Accordingly, the side lattice 103 has an approximately truncated cone shape. In this embodiment, two bars 113 are connected to the grill member 101 at each vertex of the rectangular shaped lower lattice 102. Here, the number and structure of bar 113 constituting the side lattice 103 as described above is only one example, it goes without saying that the lattice 103 can be variously constituted.

The plurality of air-guiding members 105 is provided at an inside of the grill body 101. The air-guiding members 105 reduce a flow rate of the air entered in the grill body 101 and then discharged to the air discharge tube 19 to reduce a noise generated in the air discharge tube 19. In addition, the air-guiding members 105 ensure that the air entering the air discharge tube 19 flow laminarily, and so a generation of turbulent flow in the air discharge tube 19 is prevented. Such air-guiding members 105, which are the additional members, but are not part of the grill body 101, can be installed in the grill body 101 or the air-guiding members 105 can be formed integrally with the grill body 101 by protruding the air-guiding members 105 from an inner surface of the grill body 101 with a certain shape. At this time, it is desirable to optimize a shape of the air-guiding members 105 through the experiments in order to show the functions as described above.

As shown in FIG. 6 to FIG. 9 the air-guiding members 105 according to this embodiment protrude from an inner surface of the grill body 101 include four air-guiding members 105 that form an air-direct passage 107 at a center.

Also, a lower end of each air-guiding member 105 is extended to an inside of the lattice member 104 and has a curved section 105a and a linear section 105b as shown in FIG. 9. The curved section 105a is directed to the lower lattice 102 of the lattice member 104. At this time, it is desirable that a lower end of the curved section 105a is extended to the lower lattice 102 of the lattice member 104 to make a side of the curved section 105a function as a role of the side lattice 103 of the lattice member 104. This curved section 105a reduces a flow rate of air entered to the air discharge tube 19 and guides this air to the linear section 105b. The linear section 150b is extended from the curved section 105a to an outlet of the air discharge tube 19 and makes the air guided by the curved section 105a flow laminarily.

Four air-guiding members 105 are formed at angular intervals of 90°. Also, as shown in FIG. 8, it is preferable that the curved sections 105a of four air-guiding members 105 are curved in the same direction (a counterclockwise direction in FIG. 8).

As shown in FIG. 7 and FIG. 8, the air-direct passage 107 is formed at an approximately center of the grill body 101 and the lattice member 104 and refers to a space in which the plurality of air-guiding members 105 do not interfere in a flow of the entered air. That is, since inner ends 105d of the plurality of air-guiding members 105 are not extended an inside of the rectangular lower lattice 102, a space extending from a rectangular formed by the lower lattice 102 toward the grill body 101 forms the air-direct passage 170 in which the air-guiding member 105 is not existed. Accordingly, the air entered to a center of the lower lattice 102 of the lattice member 104 is not guided by the air-guiding member 105 and is directly discharged to the air discharge tube 19.

The structures and functions of the cyclone body 11 and the contaminant receptacle 30 of the cyclone dust collecting apparatus 60 according to this embodiment are the same as those of the members of the cyclone dust collecting apparatus 10 according to the first embodiment, and so a detailed description thereon is omitted.

Also, the cyclone dust collecting apparatus 60 according to the present invention can further comprise the inner cover 20 provided at a lower side of the cyclone body 11 and placed at an outside of the grill unit 100 (see FIG. 2). The inner cover 20 has a hollow truncated cone shape with opened upper and lower ends. The structure of the inner cover 20 is the same as that of the inner cover in the cyclone dust collecting apparatus 10 for the vacuum cleaner of the first embodiment as described, and so a detailed description thereon is omitted.

Below, an operation of the cyclone dust collecting apparatus 60 according to the third embodiment of the present invention is described with reference to accompanied FIG. 6 to FIG. 9.

When a vacuum generating source (not shown) is turned on, the contaminant-laden air sucked from the brush (not shown) enters the air suction tube 18 through the first extension tube 8. The contaminant-laden passes through the air suction passage 13 (see FIG. 3) to form a whirling helical vortex current and then enters the whirling space S′ formed by the side wall 12 (see FIG. 6) and the contaminant receptacle 30. While the contaminant-laden air is whirled in the whirling space S′, the contaminant contained in the contaminant-laden air is separated by a centrifugal force. The separated contaminant falls and accumulates in the contaminant receptacle 30.

In a case that the inner cover 20 (see FIG. 3) is provided at a lower end of the cyclone body 11, the contaminant-laden air is entered in the whirling space S (see FIG. 3) formed by the side wall 12 and the inner cover 20. During the contaminant-laden air is whirled in the inner cover 20, the contaminant contained in the contaminant-laden air is separated by a centrifugal force. The separated contaminant falls in the contaminant receptacle 30 through the opened lower end 22 (see FIG. 3) of the inner cover 20 and accumulates in the contaminant receptacle 30.

The contaminant is separated by a centrifugal force generated by the whirling helical vortex current as described above, the purified air is then discharged to the air discharge tube 19 through the grill unit 100.

When the purified air is passed through the grill unit 100, fine dusts and the like which was not separated from the air and remains in the purified air is filtrated again by the lattice member 104 of the grill unit 100. In addition, the flow of the purified air is stabilized by a plurality of the air-guiding members 105. That is, the purified air passed through the lattice member 104 is fluently guided by the curved section 105a of the air-guiding member 105, and so a rotational speed and a flow rate of air are lowered. Accordingly, a noise generated in the air discharge tube 19 is reduced. And, the linear section 105b of the air-guiding member 105 guides the purified air guided by the curved section 105a to form a laminar flow, and so it prevents the turbulent flow from generating in the air discharge tube 19. Accordingly, a flow rate of the purified air sucked in the grill unit 100 is reduced and a flow of air becomes the laminar flow and stabilized by a plurality of the air-guiding members 105.

After passing through the grill unit 100 and entering in the air discharge tube 19 in a stable state as described above, the purified air is passed through the second extension tube 9 and the main body of the vacuum cleanser (not shown) and then discharged to an exterior.

In the cyclone dust collecting apparatus 60 for the vacuum cleaner according to the third embodiment of the present invention as described above, during the purified air from which the contaminant is separated by a centrifugal force generated by the whirling helical vortex current is passed through the grill unit 100, the contaminant remained in the purified air is removed by the lattice member 104 and a flow of the purified air is stabilized by the plurality of air-guiding members 105, and so a pressure loss and a noise caused by a turbulent flow generated in the grill unit 100 through which the purified air is passing are reduced.

Also, in a case that the cyclone dust collecting apparatus 60 for the vacuum cleaner according to the present invention comprises the inner cover 20, since the space S in which the sucked contaminant-laden air is whirled and the space in which the contaminant is accumulated are separated from each other by the inner cover 20, the dust collection efficiency is enhanced and it is possible to prevent the contaminant collected in the contaminant receptacle 30 from be re-scattering.

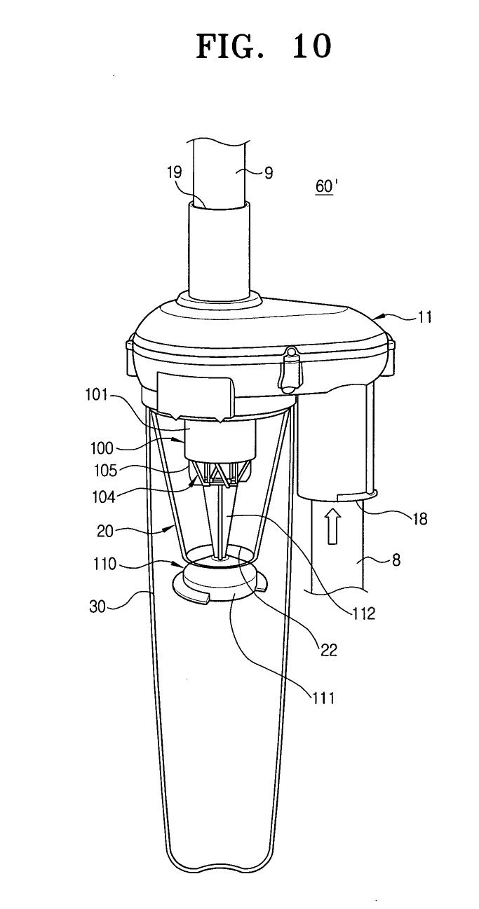

Below, according to another aspect of the present invention, the cyclone dust collecting apparatus according to the fourth embodiment of the present invention is described with reference to accompanied FIG. 10.

Referring to FIG. 10, a cyclone dust collecting apparatus 60′ according to the fourth embodiment of the present invention comprises the cyclone body 11, the grill unit 100, a backflow preventing member 110, the inner cover 20 and the contaminant receptacle 30.

The grill unit 100 is installed at a lower end of the air discharge tube 19 and includes the grill body 101, the lattice member 104, and the plurality of air-guiding members 105. The structures of the grill body 101, the lattice member 104 and the plurality of air-guiding members 105 constituting the grill unit 100 are same as those of the grill body, the lattice member and the plurality of air-guiding members constituting the grill unit 100 of the cyclone dust collecting apparatus 60 for the vacuum cleaner according to the third embodiment as described above, and so a detailed description thereon is omitted.

The backflow preventing member 110 is provided to prevent the contaminant collected in the contaminant receptacle 30 from backflowing through the opened lower end 22 of the inner cover 20, this member is extended from a lower end of the grill unit 100 (that is, the lower lattice 102 (see FIG. 7) of the lattice member 104) to an outside of the opened lower end 22 of the inner cover 20. This backflow preventing member 110 includes a skirt 111 and an extension column 112. The skirt 111 corresponds to the opened lower end 22 of the inner cover 20 and is spaced apart from the opened lower end 22 of the inner cover 20 for preventing the contaminant accumulated in the contaminant receptacle 30 from backflowing and enabling the contaminant to fall through the opened lower end 22 of the inner cover 20. Accordingly, a diameter of the skirt 111 is the same as or larger than that of the opened lower end 22 of the inner cover 20. The extension column 112 connects the skirts 111 and the lower end of the grill unit 100 and functions as a role for fixing the skirt 111 to the grill unit 100. It is preferable that the extension column 112 is fixed to the lower lattice 102 of the grill unit 100 for preventing it from separating from the grill unit 100.

On the other hand, the grill unit 100 can be attachably/detachably coupled with a lower end of the air discharge tube 19 (see FIG. 6). That is, the grill unit 100 is installed such that an upper end of the grill unit 100, that is, an upper end of the grill body 101 can be separated from and coupled with the lower end of the air discharge tube 19. At this time, the one touch connection method can be applicable to the methods for separating/coupling the grill body 101 of the grill unit 100 from/with the air discharge tube 19, and so a detailed description thereon is omitted. Also, it is preferable that the grill unit 100 is sized such that the grill unit 100 can be passed through the opened lower end 22 of the inner cover 20, and so there is no need to separate the inner cover 20 when the grill unit 100 is separated from the air discharge tube 19. That is, it is desirable that a maximum diameter of the grill unit 100 is smaller than a diameter of the opened lower end 22 of the inner cover 20.

Also, the structures and functions of the cyclone body 11, the inner cover 20 and the contaminant receptacle 30 of the cyclone dust collecting apparatus 60′ according to this embodiment are the same as those of the members of the cyclone dust collecting apparatus 10 according to the first embodiment, and so a detailed description thereon is omitted.

Also, an operation of the cyclone dust collecting apparatus 60′ according to the fourth embodiment is the same as those of the cyclone dust collecting apparatuses 10′ and 60 according to the second and third embodiments, and so a detailed description thereon is omitted. That is, refer to the cyclone dust collecting apparatus 60 according to the third embodiment for understanding an operation of the grill unit 10 of this embodiment, and refer to the cyclone dust collecting apparatus 10′ according to the second embodiment for understanding an operation of the backflow preventing member 110.

In the cyclone dust collecting apparatus 60′ for the vacuum cleaner according to the fourth embodiment of the present invention as described above, during the purified air from which the contaminant is separated by a centrifugal force generated by the whirling helical vortex current is passed through the grill unit 100, the contaminant remained in the purified air is removed by the lattice member 104 and a flow of the purified air is stabilized by the plurality of air-guiding members 105, and so a pressure loss and a noise caused by a turbulent flow generated in the grill unit 100 through which the purified air is passing are reduced.

Also, since the space S in which the sucked contaminant-laden air is whirled is separated from the space in which the contaminant is accumulated by the inner cover 20 and the skirt 111 prevents the contaminant collected in the contaminant receptacle 30 from backflowing toward the grill unit 100, the dust collection efficiency is enhanced and it is possible to prevent the contaminant collected in the contaminant receptacle 30 from backflowing. Also, in a case that there is need to clean the grill unit 100, only the grill unit 100 can be drawn out through the opened lower end 22 of the inner cover 20 without separating the inner cover 20, and so the cyclone dust collecting apparatus is convenient for clean.

While the invention has been shown and described with reference to certain embodiments thereof, it will be understood by those skilled in the art that various changes in form and details may be made therein without departing from the spirit and scope of the invention as defined by the appended claims.

What is claimed is:

1. A cyclone dust collecting apparatus for a vacuum cleaner comprising
a cyclone body connected to an extension tube and an air discharge tube;
an inner cover provided at a lower side of the cyclone body, the inner cover having a hollow conical shape with an opened upper end and an opened lower end;
a grill unit for filtering contaminant contained in air discharged to the air discharge tube, the grill unit being provided at a lower end of the air discharge tube in the inner cover; and
a contaminant receptacle for receiving a contaminant from the inner cover, the contaminant receptacle being provided at a lower side of the inner cover.

2. The cyclone dust collecting apparatus for the vacuum cleaner according to claim 1, wherein the grill unit comprises a backflow preventing member extended from a lower end of the grill unit to an outside of the opened lower end of the inner cover.

3. The cyclone dust collecting apparatus for the vacuum cleaner according to claim 2, wherein the back flow preventing member comprises
a skirt spaced apart from the opened lower end of the inner cover and having a diameter that is the same as or larger than that of the opened lower end of the inner cover; and
an extension column connecting the skirt and a lower end of the grill unit.

4. The cyclone dust collecting apparatus for the vacuum cleaner according to claim 2, wherein the grill unit is attachably/detachably coupled with at a lower end of the air discharge tube.

5. The cyclone dust collecting apparatus for the vacuum cleaner according to claim 4, wherein the grill unit is sized such that the grill unit can be passed through the opened lower end of the inner cover.

6. The cyclone dust collecting apparatus for the vacuum cleaner according to claim 2, wherein the grill unit further comprises a lattice member for filtering contaminant contained in the air which is discharging to the air discharge tube, the plurality of the air-guiding members are provided at an inside of the lattice member to stabilize the air which is discharging through the lattice member.

7. The cyclone dust collecting apparatus for the vacuum cleaner according to claim 2, wherein the grill unit includes plurality of air-guiding members for stabilizing the air discharged to the air discharge tube.

8. The cyclone dust collecting apparatus for the vacuum cleaner according to claim 1, wherein the grill unit has a truncated cone shape which is similar to a shape of the inner cover.

9. The cyclone dust collecting apparatus for the vacuum cleaner according to claim 1, wherein the grill unit further comprises a lattice member for filtering contaminant contained in the air which is discharging to the air discharge tube, the plurality of the air-guiding members are provided at an inside of the lattice member to stabilize the air which is discharging through the lattice member.

10. The cyclone dust collecting apparatus for the vacuum cleaner according to claim 1, wherein the grill unit includes plurality of air-guiding members for stabilizing the air discharged to the air discharge tube.

11. A cyclone dust collecting apparatus for a vacuum cleaner comprising
a cyclone body connected to an extension tube and an air discharge tube;
a grill unit being provided at a lower end of the air discharge tube for filtering contaminant contained in air which is discharging air, the grill unit including a plurality of air-guiding members for stabilizing air discharged to the air discharge tube; and
a contaminant receptacle for receiving the contaminant from air which is sucked from the cyclone body and is whirling, the contaminant receptacle being provided at a lower side of the cyclone body.

12. The cyclone dust collecting apparatus for the vacuum cleaner according to claim 11, wherein the grill unit further comprises a lattice member for filtering contaminant contained in the air which is discharging to the air discharge tube, the plurality of the air-guiding members are provided at an inside of the lattice member to stabilize the air which is discharging through the lattice member.

13. The cyclone dust collecting apparatus for the vacuum cleaner according to claim 11, wherein the grill member comprises
a hollow cylindrical shaped grill member communicated with the air discharge tube;
a plurality of air-guiding member protruded on an inside surface of the grill member in the shape of a plate and having a curved section and a linear section; and
a lattice member provided at a lower side of the grill member and having an approximately truncated cone shape.

14. The cyclone dust collecting apparatus for the vacuum cleaner according to claim 13, wherein each of the plurality of air-guiding members has a lower end extended to an inside of the lattice member.

15. The cyclone dust collecting apparatus for the vacuum cleaner according to claim 14, wherein the grill unit comprises four air-guiding members formed at an inside of the grill body at angular intervals of 90°.

16. The cyclone dust collecting apparatus for the vacuum cleaner according to claim 15, wherein the grill unit has an air-direct passage formed at a central portion thereof, the air entered in the air discharge tube is directly discharged through the air-direct passage at which the air is not guided by four air-guiding members.

17. The cyclone dust collecting apparatus for the vacuum cleaner according to claim 11, further comprising an inner cover installed at a lower side of the cyclone body and placed at an outside of the grill unit, the inner cover has a hollow truncated cone shape with an opened upper end and an open lower end.

18. The cyclone dust collecting apparatus for the vacuum cleaner according to claim 17, wherein the grill unit comprises a backflow preventing member extended from a lower end of the grill unit to an outside of the opened lower end of the inner cover.

19. The cyclone dust collecting apparatus for the vacuum cleaner according to claim 18, wherein the back flow preventing member comprises:
a skirt spaced apart from an opened lower end of the inner cover and having a diameter which is the same as or larger than that of the opened lower end of the inner cover; and
an extension column connecting the skirt and the lower end of the grill unit.

20. The cyclone dust collecting apparatus for the vacuum cleaner according to claim 19, wherein the grill unit is attachably/detachably coupled with the lower end of the air discharge tube.

21. The cyclone dust collecting apparatus for the vacuum cleaner according to claim 20, wherein the grill unit is sized such that the grill unit can be passed through the opened lower end of the inner cover.
